(19) United States
(12) Patent Application Publication
(10) Pub. No.: US 2022/0172041 A1
(43) Pub. Date: Jun. 2, 2022

(54) DOCUMENT CLASSIFICATION USING THIRD-PARTY REVIEW AND FEEDBACK

(71) Applicant: KYOCERA DOCUMENT SOLUTIONS INC., OSAKA (JP)

(72) Inventors: Oleksandr Zinchenko, Concord, CA (US); Hiroyuki Takaishi, Osaka (JP)

(21) Appl. No.: 17/108,417

(22) Filed: Dec. 1, 2020

(51) Int. Cl. G06N 3/08; G06N 3/04; G06F 16/93

(52) U.S. Cl. CPC G06N 3/08; G06F 16/93; G06N 3/04

(57) ABSTRACT

A method includes retrieving a plurality of document specifications and generating training set data based on the plurality of document specifications. The method includes running a classification engine to cause the classification engine to perform a first set of operations. The first set of operations includes generating a classification model using the training set data, determining one or more classification labels for a particular document and a corresponding confidence value for each classification label, and generating a classification report for the particular document. The method includes running a verification engine to cause the verification engine to perform a second set of operations. The second set of operations include requesting third-party review of the classification report, assigning a particular classification label to the particular document, and transmitting the particular document and the particular classification label as feedback. The method includes updating the training set data based on the feedback.

### BACKGROUND

In recent history, enterprises often use classification engines to classify documents. As a non-limiting example, a classification engine can classify a first document as belonging to a first document class and can classify a second document as belonging to a second document class. There are a variety of techniques for performing document classification and a variety of classification engines used to perform document classification. However, in general, classification engines are often subject to an undesirable degree of error.

### SUMMARY

In one aspect, a system for document classification includes an electronic database configured to store a plurality of document specifications. Each document specification has a corresponding classification label and one or more example documents associated with the classification label. The plurality of document specifications are usable by a processor to generate training set data for a classification engine. The classification engine is configured to generate a classification model using the training set data and receive a particular document. Based on the classification model, the classification engine is configured to determine one or more classification labels for the particular document and a corresponding confidence value for each classification label. The classification engine is also configured to generate a classification report for the particular document. The classification report includes the particular document, the one or more classification labels, and the corresponding confidence value. The system also includes a verification engine configured to request third-party review of the classification report. Based on the third-party review, the verification engine is configured to assign a particular classification label to the particular document. The verification engine is also configured to transmit the particular document and the particular classification label to the electronic database as feedback. The feedback is usable by the processor to update the training set data.

In a further aspect, a method of document classification includes retrieving, at a processor, a plurality of document specifications stored at an electronic database. Each document specification has a corresponding classification label and one or more example documents associated with the classification label. The method also includes generating training set data based on the plurality of document specifications. The method further includes running a classification engine to cause the classification engine to perform a first set of operations. The first set of operations includes generating a classification model using the training set data and, based on the classification model, determining one or more classification labels for a particular document and a corresponding confidence value for each classification label. The first set of operations also includes generating a classification report for the particular document, the classification report including the particular document, the one or more classification labels, and the corresponding confidence values. The method also includes running a verification engine to cause the verification engine to perform a second set of operations. The second set of operations include requesting third-party review of the classification report and, based on the third-party review, assigning a particular classification label to the particular document. The second set of operations also includes transmitting the particular document and the particular classification label to the electronic database as feedback. The method also includes updating the training set data based on the feedback.

In a further aspect, a non-transitory computer-readable storage medium includes instructions, that when executed by a processor, cause the processor to perform functions. The functions include retrieving a plurality of document specifications stored at an electronic database. Each document specification has a corresponding classification label and one or more example documents associated with the classification label. The functions also include generating training set data based on the plurality of document specifications. The functions further include running a classification engine to cause the classification engine to perform a first set of operations. The first set of operations includes generating a classification model using the training set data and, based on the classification model, determining one or more classification labels for a particular document and a corresponding confidence value for each classification label. The first set of operations also includes generating a classification report for the particular document, the classification report including the particular document, the one or more classification labels, and the corresponding confidence values. The functions also include running a verification engine to cause the verification engine to perform a second set of operations. The second set of operations include requesting third-party review of the classification report and, based on the third-party review, assigning a particular classification label to the particular document. The second set of operations also includes transmitting the particular document and the particular classification label to the electronic database as feedback. The functions also include updating the training set data based on the feedback.

These as well as other aspects, advantages, and alternatives will become apparent to those of ordinary skill in the art by reading the following detailed description with reference where appropriate to the accompanying drawings. Further, it should be understood that the description provided in this summary section and elsewhere in this document is intended to illustrate the claimed subject matter by way of example and not by way of limitation.

### BRIEF DESCRIPTION OF THE DRAWINGS

FIG. 1 is a diagram of a document classification system, according to an example embodiment.

FIG. 2 illustrates a plurality of document specifications, according to an example embodiment.

FIG. 3 illustrates generating training set data using the plurality of document specifications, according to an example embodiment, according to an example embodiment.

FIG. 4 illustrates a verification process with a third party, according to an example embodiment.

FIG. 5 illustrates a process for modifying the plurality of document specifications using feedback, according to an example embodiment.

FIG. 6 illustrates another process for modifying the plurality of document specifications using feedback, according to an example embodiment.

FIG. 7 illustrates a verification process with a third party, according to an example embodiment.

FIG. 8 illustrates another process for modifying the plurality of document specifications using feedback, according to an example embodiment.

FIG. 9 is a simplified block diagram of a computing device, according to an example embodiment.

FIG. 10 is a flowchart of a method, according to an example embodiment.

### DETAILED DESCRIPTION

Example methods and systems are described herein. Other example embodiments or features may further be utilized, and other changes may be made, without departing from the scope of the subject matter presented herein. In the following detailed description, reference is made to the accompanying figures, which form a part thereof

The ordinal terms first, second, and the like in the description and in the claims are used for distinguishing between similar elements and not necessarily for describing a sequence, either temporally, spatially, in ranking, or in any other manner. As such, it is to be understood that the ordinal terms can be interchangeable under appropriate circumstances.

The example embodiments described herein are not meant to be limiting. Thus, aspects of the present disclosure, as generally described herein and illustrated in the figures, can be arranged, substituted, combined, separated, and designed in a wide variety of different configurations, all of which are explicitly contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### I. Overview

Illustrative embodiments relate to document classification systems and corresponding document classification methods. A document classification system may include a knowledge base subsystem (e.g., an electronic database) configured to store different document specifications. The document specifications can describe document types and also provide examples of how different documents may look. Users can access the knowledge base subsystem via one or more interface elements in order to onboard new document specifications, onboard new examples of documents, delete document specifications, and learn about documents, etc.

The document classification system can also include a classification engine that can classify documents. For example, the classification engine can extract a training set (e.g., a set of example documents) from the knowledge base subsystem and generate a classification model based on the training set. Using the classification model, the classification engine can classify a particular document. For example, the classification engine can assign a classification label to the particular document to produce a “classified document.” As used herein, a “classified document” corresponds to a document that has been classified by a classification engine. For example, a classified document has at least one classification label assigned by the classification engine.

A qualitative review subsystem (e.g., a verification engine) can receive each classified document and presents the classified document to a third party (e.g., an expert) to review the classification. The third party can verify the classification or modify the classification. If the third party verifies the classification, the qualitative review subsystem can export the classified document to an external system. Additionally, the qualitative review subsystem may provide positive feedback to the knowledge base subsystem. As used herein, “positive feedback” can be the result of a third party verification of the classification performed by the classification engine. For example, positive feedback can indicate that no changes are to be made to the document specification in the knowledge base subsystem or can result in changes that reinforce or complement the document specifications in the knowledge base subsystem. However, if the third party modifies the classification, the qualitative review subsystem changes the classification based on the modification, exports the document to the external system with the modified classification, and provides negative feedback to the knowledge base subsystem. As used herein, “negative feedback” can result in a change to at least one document specification in the knowledge base subsystem based on the third party review or an addition of a document specification in the knowledge base subsystem based on the third party review.

The classification engine can “re-train” the classification model based on the feedback. For example, the classification engine can extract an updated training set from the knowledge base subsystem after changes to the document specifications have been made in light of the third party review. Based on the updated training set, the classification engine can re-train the classification model to achieve real-time classification accuracy improvement.

Thus, the document classification system can dynamically improve document classification accuracy using feedback from a third party expert and re-training a classification model based on the feedback. Other benefits will be apparent to those skilled in the art.

### II. Example Systems and Methods

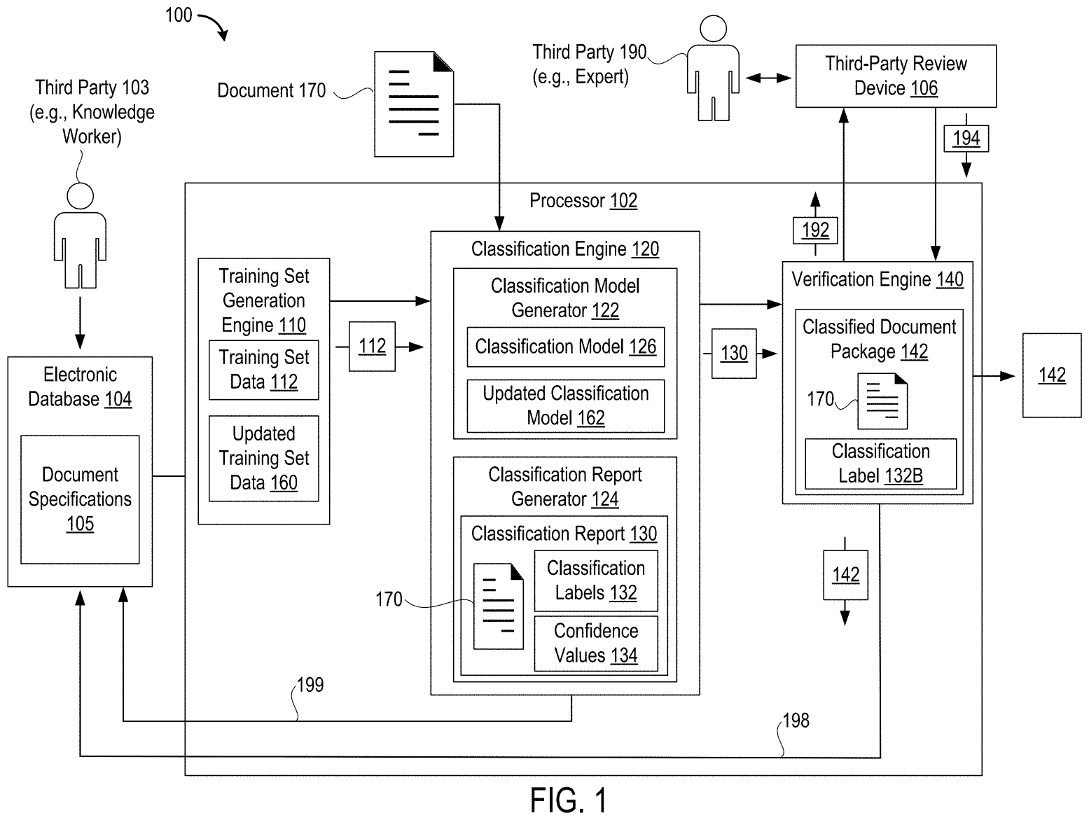

FIG. 1 depicts a diagram of a document classification system 100, according to an example embodiment. As shown, the system 100 includes a processor 102, an electronic database 104 coupled to the processor 102, and a third-party review device 106. The processor 102 can be a central processing unit (CPU), a graphics processing unit (GPU), a digital signal processor (DSP), etc. The processor 102 includes a training set generation engine 110, a classification engine 120, and a verification engine 140. According to some implementations, the training set generation engine 110 is integrated into the classification engine 120.

The electronic database 104 is configured to store a plurality of document specifications 105. For example, the electronic database 104 can be a “knowledge base subsystem” that functions as a database for the document specifications 105. The electronic database 104 can be a tool that is accessible by a third party 103 (e.g., a knowledge worker or expert). The third party 103 can manage, add, modify and delete document specifications 105 in the electronic database 104. According to one implementation, the electronic database 104 includes a user interface to enable one or more personnel, such as the third party 103, to search the plurality of document specifications 105, modify at least one document specification of the plurality of document specifications 105, and add a document specification to the plurality of document specifications 105. Although the third party 103 is illustrated in FIG. 1, in other implementations, the electronic database 104 can be operated by an external system. As used herein, an “external system” is any other system that could be integrated or connected to the document classification system 100 via an application programming interface (API) or computer interaction.

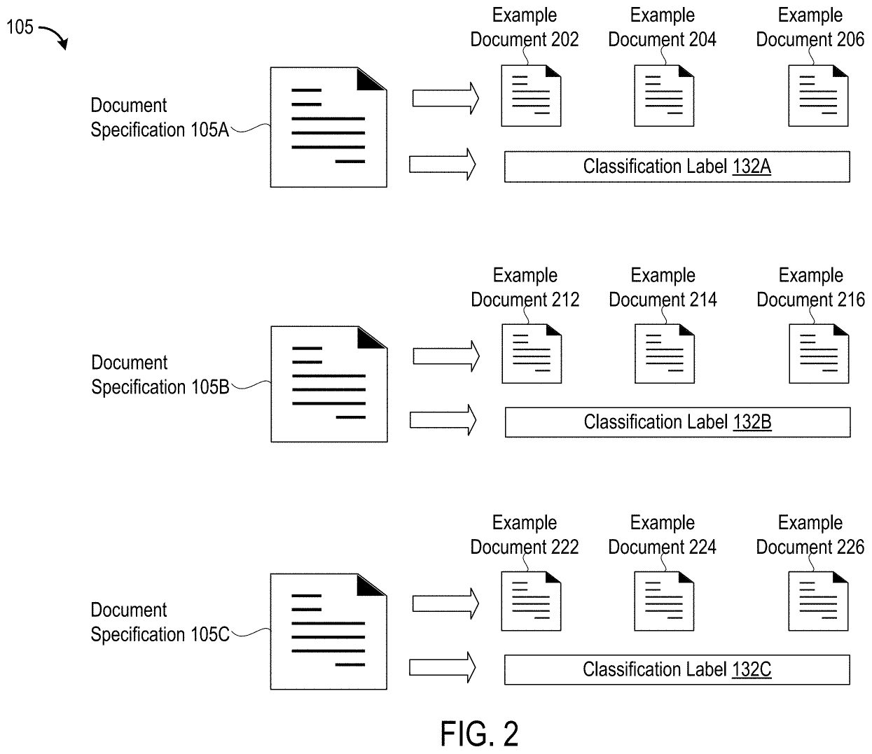

As described below, the document specifications 105 are usable by the processor 102 to generate training set data 112 for the classification engine 120. Each document specification 105, alongside with some technical description of the document, has multiple examples of how that particular document type looks. These examples are real-world examples of the documents that can be used by knowledge workers as a reference. As described with respect to FIG. 2, each document specification 105 has a corresponding classification label and one or more example documents associated with the classification label.

FIG. 2 depicts non-limiting examples of the document specifications 105 stored in the electronic database 104. As illustrated in FIG. 2, the document specifications 105 include a document specification 105A, a document specification 105B, and a document specification 105C. Although three document specifications 105A-C are illustrated in FIG. 2, in other implementations, additional (or fewer) document specifications can be included in the plurality of document specifications 105. As a non-limiting example, the plurality of document specifications 105 can include four hundred (400) document specifications, one thousand (1000) document specifications, etc.

The document specification 105A is associated with a classification label 132A and includes example documents 202, 204, 206 classified under the classification label 132A. For example, each of the documents 202, 204, 206 are provided as examples of documents that are classified with the classification label 132A. The document specification 105B is associated with a classification label 132B and includes example documents 212, 214, 216 classified under the classification label 132B. For example, each of the documents 212, 214, 216 are provided as examples of documents that are classified with the classification label 132B. The document specification 105C is associated with a classification label 132C and includes example documents 222, 224, 226 classified under the classification label 132C. For example, each of the documents 222, 224, 226 are provided as examples of documents that are classified with the classification label 132C.

Thus, the document specifications 105 include multiple examples of real-world documents of particular types or classifications. As explained below, these real-world examples are fetched and used by the classification engine 120 as a training set in order to create a classification model that is used to classify new unclassified documents. Additionally, the document specifications 105 include a document description that is oriented on knowledge workers. As used herein, a “knowledge worker” is a person that has knowledge about documents and specifications. A knowledge worker can create, update, and manage document specifications using the electronic database 104. The description can be used to identify key differences between different document types.

Referring back to FIG. 1, the training set generation engine 110 is configured to generate the training set data 112 based on the document specifications 105. For example, according to some implementations, the training set data 112 is composed of at least some of the example documents 202-206, 212-216, 222-226 from the document specifications 105A-C, respectively, that are stored in the electronic database 104. By extracting the example documents 202-206, 212-216, 222-226 along with their corresponding classification labels 132A-132C, the training set generation engine 110 can generate the training set data 112 (e.g., classification training sets) used to train the classification engine 120.

There are multiple techniques that can be used for selecting example documents in order to compose the training set data 112. According to one technique, the training set generation engine 110 can retrieve all of the available example documents 202-206, 212-216, 222-226 to compose the training set data 112. According to another technique, the training set generation engine 110 can use random sampling in order to select a subset of the available example documents 202-206, 212-216, and 222-226 to compose the training set data 112. According to yet another technique, the training set generation engine 110 can use a ranking system that ranks the example documents 202-206, 212-216, 222-226 based on similarity (or other parameters) and can compose the training set data 112 based on the ranking. According to yet another technique, the training set generation engine 110 can use a guided selection by an expert or third party to prioritize which example documents 202-206, 212-216, 222-226 are to be used to compose the training set data 112.

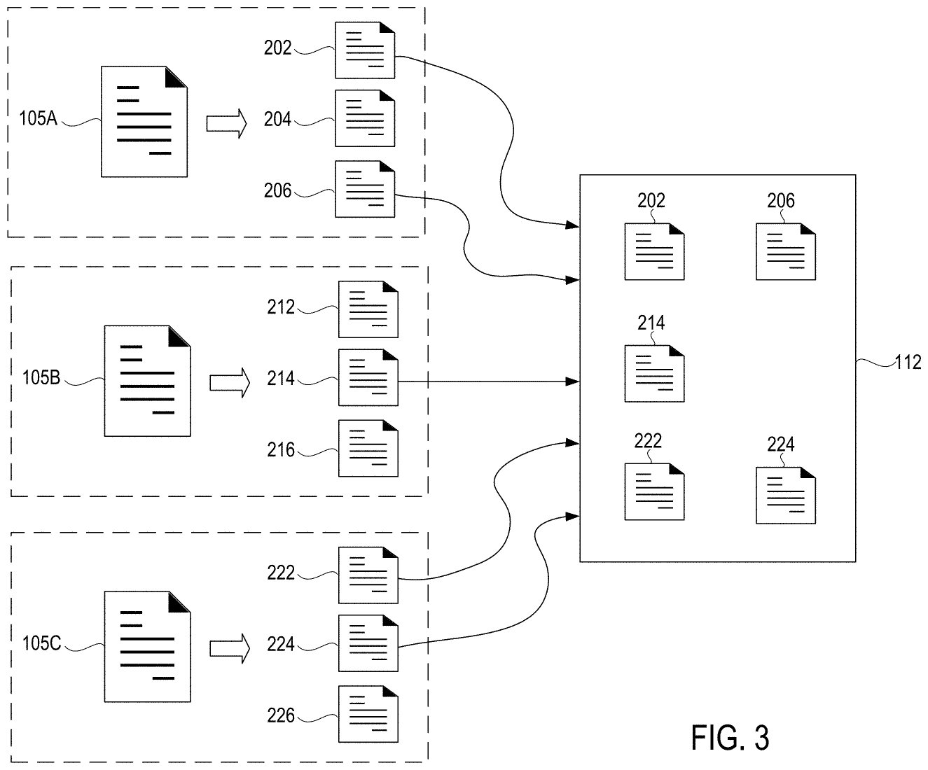

Referring to FIG. 3, a non-limiting example of extracting example documents to compose the training set data 112 is illustrated. For example, to generate the training set data 112, the example documents 202, 206 are extracted from the document specification 105A, the example document 214 is extracted from the document specification 105B, and the example documents 222, 224 are extracted from the document specification 105C. It should be understood that the extractions illustrated with respect to FIG. 3 are merely for illustrative purposes and should not be construed as limiting. The training set generation engine 110 provides the training set data 112 to the classification engine 120.

Referring back to FIG. 1, the classification engine 120 includes a classification model generator 122 and a classification report generator 124. The classification model generator 122 is configured to generate the classification model 126 using the training set data 112. For example, the classification model generator 122 may use training sets (e.g., the training set data 112) to create a machine learning model (e.g., the classification model 126) to classify documents. According to one implementation, the classification engine 120 is based on natural language processing (NLP). In this implementation, the training set data 112 is used to generate the classification model 126 that enables the classification engine 120 to perform NLP classifications based on the existing document specifications 105. According to another implementation, the classification engine 120 is based on a convolutional neural network (CNN). In this implementation, the training set data 112 is used to generate the classification model 126 that enables the classification engine 120 to perform CNN classifications based on the existing document specifications 105.

As described below, once the classification model 126 is generated, the classification model generator 122 can improve or re-train the classification model 126 based on an updated version of the training set data 112 (e.g., updated training set data 160), such as a version of the training set data 112 based on new document classes, removed legacy data, removed unused data, etc.

The classification engine 120 can receive documents (e.g., an “unclassified” document) from an external system or source (not shown). The classification engine 120 is configured to classify the document 170 using the classification model 126 generated from the training set data 112. For example, using the classification model 126, the classification engine 120 is configured to determine one or more classification labels 132 for the document 170 and a corresponding confidence value 134 for each classification label 132. To illustrate, the classification engine 120 can assign the classification label 132A to the document 170, the classification label 132B to the document, and the classification label 132C to the document 170. The classification engine 120 can also assign confidence values 134 for each of the assigned classification labels 132A-C. As a non-limiting illustrative example, on a confidence value scale from one (1) to one-hundred (100) with one-hundred (100) being the highest value, the classification engine 120 can assign a confidence value 134 of ninety (90) to the classification label 132A, a confidence value 134 of seven (7) to the classification label 132B, and a confidence value 134 of three (3) to the classification label 132C. Other confidence values are possible.

The classification report generator 124 is configured to generate a classification report 130 for the document 170 after the classification engine 120 determines the classification labels 132 and the corresponding confidence values 134. The classification report 130 includes the document 170, the classification labels 132, and the confidence value 134 for each classification label 132. The classification engine 120 is configured to provide the classification report 130 to the verification engine 140.

The verification engine 140 is configured to request third-party review of the classification report 130 to classify, or verify the classification of, the document 170. For example, upon receiving the classification report 130, the verification engine 140 is configured to send a verification request 192 to the third-party review device 106. The verification request 192 may include the classification report 130.

Upon receiving the verification request 192, the third-party review device 106 presents the classification report 130 to a third party 190 for review and approval. In some embodiments, the third party 190 can be an expert or a person who has a high level of knowledge about documents and classifications. For example, the third party 190 can easily identify misclassified documents or mismatches between the document specifications 105 and a current state of business. The third party 190 reviews the classification report 130 and verifies the classification of the document 170.

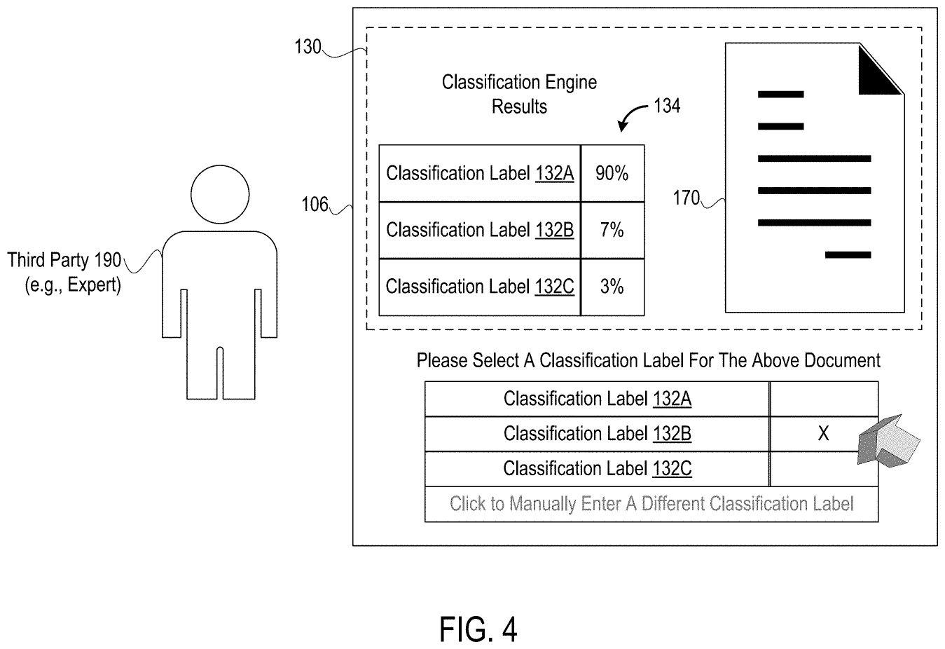

Referring to FIG. 4, an illustrative example of the classification report 130 presented to the third party 190 via the third-party review device 106 is shown. The third-party review device 106 displays the document 170, the classification labels 132A-C assigned by the classification engine 120, and the corresponding confidence values 134. For example, the “classification engine results” displayed at the third-party review device 106 indicate that there is a ninety percent (90%) likelihood that the document 170 is associated with the classification label 132A, a seven percent (7%) likelihood that the document 170 is associated with the classification label 132B, and a three percent (3%) likelihood that the document 170 is associated with the classification label 132C.

Additionally, there is an interactive field where the third party 190 can select a classification label 132 for the document 170. The interactive field allows the third party 190 to select one of the classification labels 132A, 132B, 132C in the classification report 130 as the correct classification label for the document 170 or to manually enter a different classification label as the correct classification label for the document 170. According to the illustration in FIG. 4, the third party 190 selects the classification label 132B as the correct classification label for the document 170.

Thus, after the document 170 has been classified by the classification engine 120, the document 170 is sent to a qualitative review subsystem (e.g., the verification engine 140 and the third-party review device 106) where the third party 190 can review and approve the classification. The third party 190 is able to see several classification options (e.g., document classes) alongside with the confidence level of the classification engine 120 for every document class. The third party 190 can use this information to (i) make a better decision about the document 170, (ii) make a judgment about the quality of the classification engine 120, and (iii) make a judgment about the quality of the classification model 126. If required, the third party 190 can refer to the electronic database 104 to check how the document specifications 105 look and find the subset of the document specifications that has been used as the training set.

Referring back to FIG. 1, based on the selection by the third party 190, the third-party review device 106 sends a selection signal 194 to the verification engine 140. The selection signal 194 indicates the selected classification label 132B for the document 170. According to some implementations, the third-party review device 106 is integrated into the verification engine 140 such that transmission of the verification request 192 and the selection signal 194 can be bypassed and the third party 190 can directly interact with the verification engine 140.

In response to receiving the selection signal 194 indicating the classification label 132B, the verification engine 140 is configured to assign the classification label 132B to the document 170 to classify the document 170. For example, the verification engine 140 generates a classified document package 142 that includes the document 170 and the classification label 132A such that the document 170 is a “classified document.” The verification engine 140 is configured to (i) export the classified document package 142 to an external system (not shown) and to (ii) transmit the classified document package 142 to the electronic database 104 as feedback via a feedback loop 198. Thus, the verification engine 140 transmits the document 170 and the classification label 132B to the electronic database 104 after classification and review from the third party 190. As described below, the feedback (e.g., the document 170 and the classification label 132B) is usable by the processor 102 to update the training set data 112.

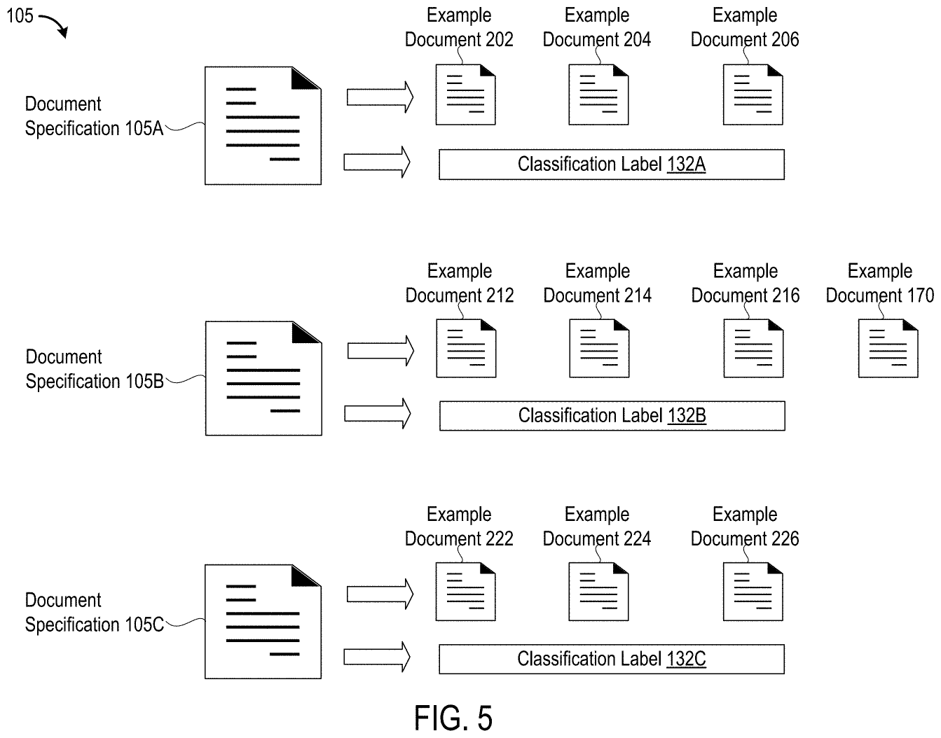

To update the training set data 112 based on the feedback, the processor 102 is configured to modify the document specifications 105 (using the feedback) that are used to compose the training set data 112 to generate updated training set data 160. According to one implementation, as feedback, the document 170 is added as an example document to the document specification 105B stored in the electronic database 104. For example, in response to a determination by the verification engine 140 that the document 170 is associated with the classification label 132B, the processor 102 is configured to add the document 170 to the example documents 212, 214, 216 in the electronic database 104 that are associated with the classification label 132B, as illustrated in FIG. 5.

According to another implementation, as feedback, the document 170 is used to delete one or more example documents 206 from the document specification 105A stored in the electronic database 104. The document specification 105A has a classification label 132A that is different from the classification label 132B of the document 170, and the one or more example documents 206 that are deleted have similar characteristics of the document 170. To illustrate, the processor 102 can delete the example document 206 from the document specification 105A in response to a determination that example document 206A has similar characteristics as the document 170 and in response to the determination that the document 170 is classified under the classification label 132B. Deleting the example document 206 from the document specification 105A may reduce the likelihood that the classification engine 120 assigns the classification label 132A to similar documents as the document 170 in the future.

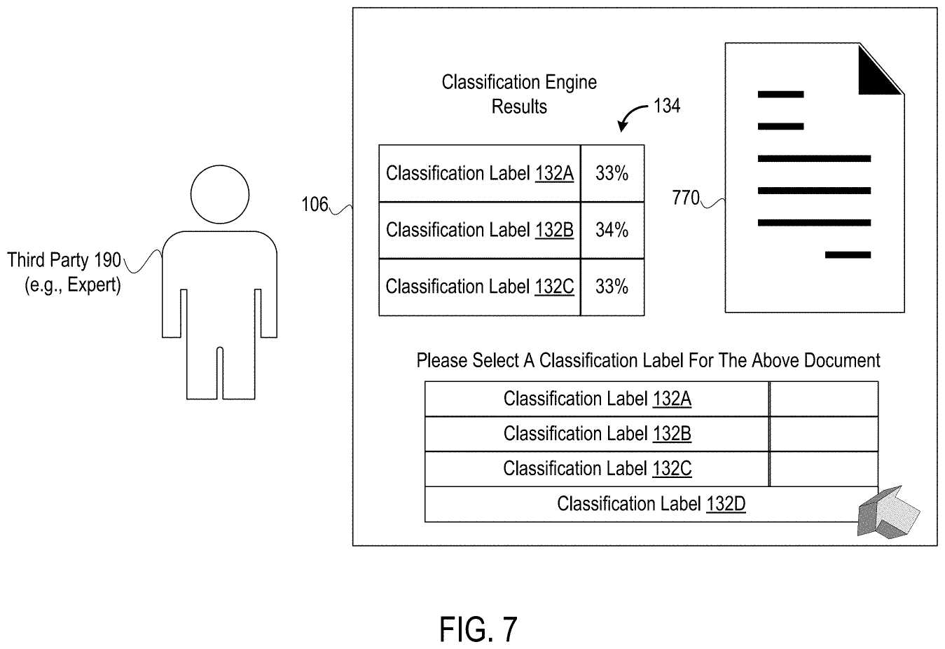

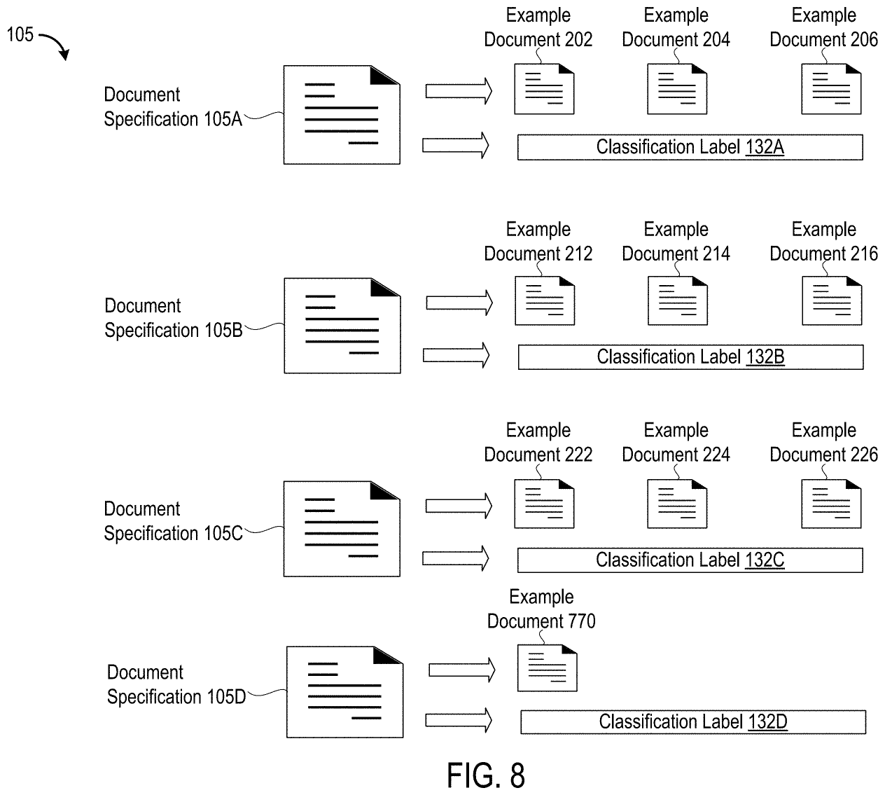

According to another implementation, as feedback, a document 770 can be used to create a new document specification 105D in the electronic database 104 in response to a determination that there is no existing document specification in the electronic database 104 having a classification label 132D associated with the document 770. To illustrate, referring to FIG. 7, the third-party review device 106 displays the document 770, the classification labels 132A-C assigned by the classification engine 120, and the corresponding confidence values 134. For example, the “classification engine results” displayed at the third-party review device 106 indicate that there is a thirty-three percent (33%) likelihood that the document 770 is associated with the classification label 132A, a thirty-four percent (34%) likelihood that the document 770 is associated with the classification label 132B, and a thirty-three percent (33%) likelihood that the document 770 is associated with the classification label 132C. In FIG. 7, the third party 190 manually enters the classification label 132D into the interactive field to classify the document 770. In this implementation, the verification engine 140 of FIG. 1 transmits the document 770 and the classification label 132D to the electronic database 104 as feedback. Because there is no existing document specification associated with the classification label 132D, the processor 102 creates the new document specification 105D in the electronic database 104 and adds the document 770 to the new document specification 105D, as illustrated in FIG. 8.

Thus, in FIGS. 5, 6, and 8, modifications to the document specifications 105 using the feedback are illustrated. Using any one of the modifications to the document specifications 105, the training set generation engine 110 can generate the updated training set data 160 using the extraction techniques described with respect to FIG. 3. For example, example documents from at least one of the modified document specifications 105 in FIGS. 5, 6, and 8 can be extracted by the training set generation engine 110 to generate the updated training set data 160 based on the feedback.

The classification engine 120 is configured to perform a retraining operation 199 to generate an updated classification model 162 using the updated training set data 160. For example, the classification model generator 122 is configured to generate the updated classification model 162 using the updated training set data 160 to classify future documents. According to one implementation, the retraining operation 199 is performed periodically. According to another implementation, the retraining operation 199 is performed in response to the updating training set data 160.

Thus, the feedback loop 198 enables interactive real-time changes to the document specifications 105 by the third party 190. For example, by using the qualitative review system (e.g., the third-party review device 106 and the verification engine 140) to review the classification of the document 170, the third party 190 can initiate changes to the document specifications 105. The changes to the document specifications 105 affect the trainings set data, and as a result, the machine learning models created by the classification engine 120. The classification engine 120 may compare the quality of the new model 162 with the existing classification model 126, and if the new model 162 is superior, the classification engine 120 can replace the existing classification model 126 with the new model 162 to improve document classification.

The techniques described with respect to FIGS. 1-8 improves document classification accuracy by using the third party 190 to review document classifications. Over time, the system 100 reduces human intervention by updating the document specifications 105 using the feedback loop 198, which in turn, improves the classification model used by the classification engine 120. For example, by updating the document specifications 105 using the feedback loop 198, the system 100 provides real-time interactive improvement to training sets and real-time interactive re-training of classification models. Reducing human intervention, such as verification by the third party 190, may also result in reduced operation expenses. Because of the iterative and flexible flow, the system 100 exposes an ability to start document processing immediately without previously created training sets and previously trained models. By taking advantage of the feedback loop 198 and the iterative re-training operation 199, the system 100 can create and improve the prediction model (and as a result accuracy) as soon as the third party 190 provides feedback via the qualitative review subsystem (e.g., the verification engine 140 and the third-party review device 106).

Additionally, the system 100 can gradually reduce review by the third party 190 if a threshold number of classifications by the classification engine 120 are verified by the third party 190. As a non-limiting example, if fifty (50) consecutive classifications by the classification engine 120 are verified by the third party 190 such that the feedback is consecutively positive, the system 100 can bypass third party verification for a particular period of time to reduce costs.

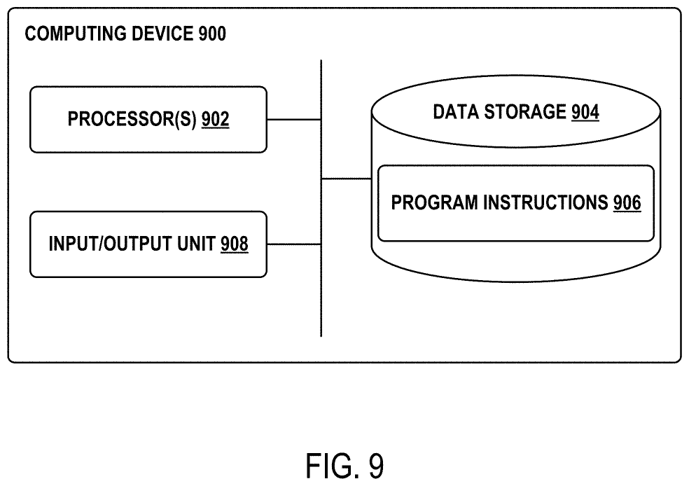

FIG. 9 illustrates a simplified block diagram of a computing device 900, which can be configured to carry out the methods, processes, or functions disclosed in this specification and/or the accompanying drawings. Any of the components described above, such as the processor 102, the electronic database 104, and/or the third-party review device 106, can be implemented as, or can be integrated within, the computing device 900. Generally, the manner in which the computing device 900 is implemented can vary, depending upon the particular application.

The computing device 900 can include one or more processors 902, data storage 904, program instructions 906, and an input/output unit 908, all of which can be coupled by a system bus or a similar mechanism. The one or more processors 902 can include one or more central processing units (CPUs), such as one or more general purpose processors and/or one or more dedicated processors (e.g., application specific integrated circuits (ASICs) or digital signal processors (DSPs), etc.). The one or more processors 902 can be configured to execute computer-readable program instructions 906 that are stored in the data storage 304 and are executable to provide at least part of the functionality described herein. According to one implementation, the one or more processors 902 can include the processor 102.

The data storage 904 can include or take the form of one or more non-transitory, computer-readable storage media that can be read or accessed by at least one of the one or more processors 902. The non-transitory, computer-readable storage media can include volatile and/or non-volatile storage components, such as optical, magnetic, organic, or other memory or disc storage, which can be integrated in whole or in part with at least one of the one or more processors 902. In some embodiments, the data storage 304 can be implemented using a single physical device (e.g., one optical, magnetic, organic, or other memory or disc storage unit), while in other embodiments, the data storage 904 can be implemented using two or more physical devices.

The input/output unit 908 can include network input/output devices. Network input/output devices can include wired network receivers and/or transceivers, such as an Ethernet transceiver, a Universal Serial Bus (USB) transceiver, or similar transceiver configurable to communicate via a twisted pair wire, a coaxial cable, a fiber-optic link, or a similar physical connection to a wireline network, and/or wireless network receivers and/or transceivers, such as a Bluetooth transceiver, a Zigbee transceiver, a Wi-Fi transceiver, a WiMAX transceiver, a wireless wide-area network (WWAN) transceiver and/or other similar types of wireless transceivers configurable to communicate via a wireless network.

The input/output unit 908 can additionally or alternatively include user input/output devices, such as the third-party review device 106, and/or other types of input/output devices. For example, the input/output unit 908 can include a touch screen, a keyboard, a keypad, a computer mouse, liquid crystal displays (LCD), light emitting diodes (LEDs), displays using digital light processing (DLP) technology, cathode ray tubes (CRT), light bulbs, and/or other similar devices.

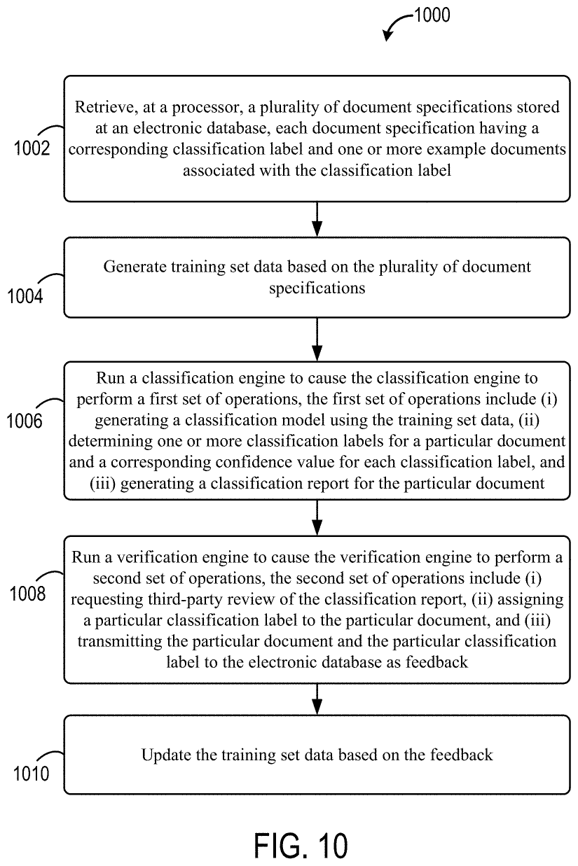

FIG. 10 depicts a flowchart of an example method 1000 that can be carried out in connection with one or more of the systems described herein. The example method 1000 can include one or more operations, functions, or actions, as depicted by one or more of blocks 1002-1010, each of which can be carried out by the systems described by way of FIGS. 1-8; however, other configurations could be used as well.

Furthermore, those skilled in the art will understand that the flowchart described herein illustrates functionality and operation of certain implementations of example embodiments. In this regard, each block of the flowchart can represent a module or a portion of program code, which includes one or more instructions executable by a processor for implementing, managing, or driving specific logical functions or steps in the method 1000. The program code can be stored on any type of computer readable medium, for example, such as a storage device including a disk or hard drive. In addition, each block can represent circuitry that is wired to perform the specific logical functions in the method 1000. Alternative implementations are included within the scope of the example embodiments of the present application in which functions can be executed out of order from that shown or discussed, including substantially concurrent order, depending on the functionality involved, as would be understood by those reasonably skilled in the art.

Referring to FIG. 10, the method 1000 includes retrieving, at a processor, a plurality of document specifications stored at an electronic database, a 1002. Each document specification has a corresponding classification label and one or more example documents associated with the classification label. For example, the processor 102 retrieves the plurality of document specifications 105 stored at the electronic database 104. Each document specification 105A-105C has a corresponding classification label 132A-132C and one or more example documents 202-206, 212-216, 222-226 associated with the classification label 132A-132C.

The method 1000 also includes generating training set data based on the plurality of document specifications, at 1004. For example, the training set generation engine 110 (or the classification engine 120) generates the training set data 112 based on the plurality of document specifications 105.

The method 1000 also includes running a classification engine to cause the classification engine to perform a first set of operations, at 1006. For example, the processor 102 runs the classification engine 120. The first set of operations includes generating a classification model using the training set data. For example, the classification model generator 122 generates the classification model 126 using the training set data 112. The first set of operations also includes, based on the classification model, determining one or more classification labels for a particular document and a corresponding confidence value for each classification label. For example, the classification engine 120 determines the classification labels 132A-132C for the document 170 and corresponding confidence values 134 for each classification label 132A-132C. The first set of operations also includes generating a classification report for the particular document. For example, the classification report generator 124 generates the classification report 130 for the document 170. The classification report 130 includes the particular document 170, the one or more classification labels 132, and the corresponding confidence values 134.

The method 1000 also includes running a verification engine to cause the verification engine to perform a second set of operations, at 1008. For example, the processor 102 runs the verification engine 140. The second set of operations include requesting third-party review of the classification report. For example, the verification engine 140 sends the verification request 192 to the third-party review device 106 to request third-party review of the classification report 130. The second set of operations also include, based on the third-party review, assigning a particular classification label to the particular document. For example, the verification engine 140 assigns the classification label 132B to the document 170 based on the third-party review. The second set of operations further include transmitting the particular document and the particular classification label to the electronic database as feedback. For example, the verification engine 140 transmits the classified document package 142 to the electronic database 104 via the feedback loop 198.

According to one implementation of the feedback, the particular document is added as an example document to a particular document specification stored in the electronic database, and the particular document specification has the particular classification label. For example, referring to FIG. 5, the processor 102 adds the document 170 as an example document to the document specification 105B stored in the electronic database 104.

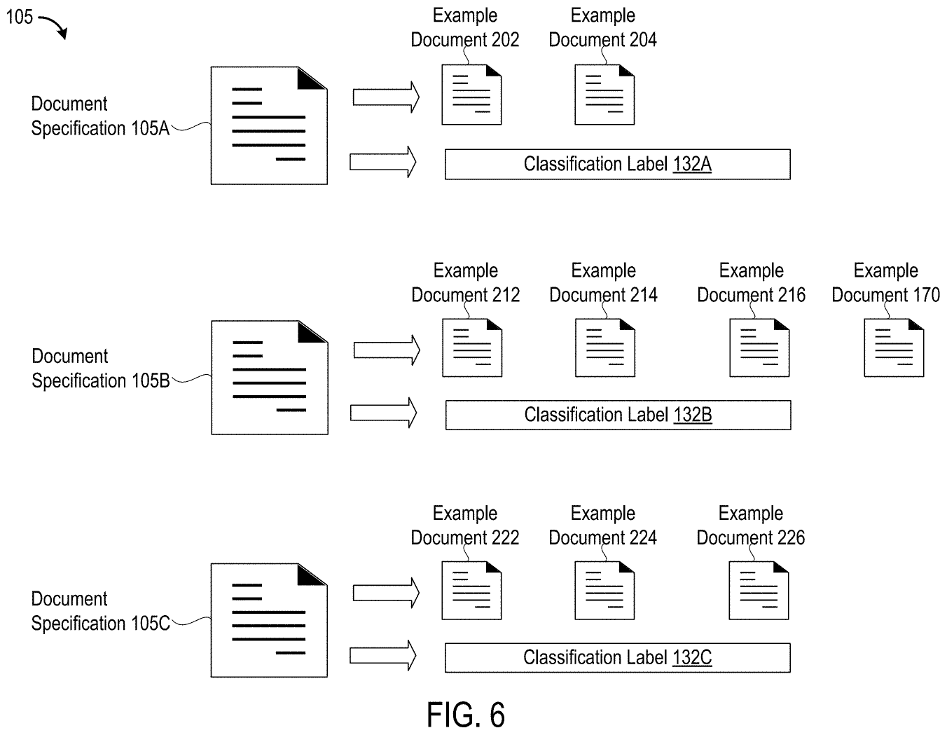

According to another implementation of the feedback, the particular document is used to delete one or more example documents from a particular document specification stored in the electronic database, the particular document specification has a classification label that is different from the particular classification label, and the one or more example documents has similar characteristics of the particular document. For example, referring to FIG. 6, the processor 102 deletes the example document 206 from the document specification 105A in response to a determination that example document 206A has similar characteristics as the document 170 and the document 170 is classified under the classification label 132B. Deleting the example document 206 from the document specification 105A may reduce the likelihood that the classification engine 120 assigns the classification label 132A to similar documents as the document 170 in the future.

According to another implementation of the feedback, the particular document is used to create a new document specification in the electronic database in response to a determination that there is no existing document specification in the electronic database having the particular classification label, and the new document specification has the particular classification label. For example, in FIG. 7, the third party 190 manually enters the classification label 132D into the interactive field to classify the document 770. In this implementation, the verification engine 140 of FIG. 1 transmits the document 770 and the classification label 132D to the electronic database 104 as feedback. Because there is no existing document specification associated with the classification label 132D, the processor 102 creates the new document specification 105D in the electronic database 104 and adds the document 770 to the new document specification 105D, as illustrated in FIG. 8.

The method 1000 also includes updating the training set data based on feedback, at 1010. For example, the training set generation engine 110 (or the classification engine 120) updates the training set data 112 based on the feedback to generate the updated training set data 160.

The method 1000 improves document classification accuracy by using the third party 190 to review document classifications. Over time, the system 100 reduces human intervention by updating the document specifications 105 using the feedback loop 198, which in turn, improves the classification model used by the classification engine 120. For example, by updating the document specifications 105 using the feedback loop 198, the system 100 provides real-time interactive improvement to training sets and real-time interactive re-training of classification models. Reducing human intervention, such as verification by the third party 190, may also result in reduced operation expenses. Because of the iterative and flexible flow, the system 100 exposes an ability to start document processing immediately without previously created training sets and previously trained models. By taking advantage of the feedback loop 198 and the iterative re-training operation 199, the system 100 can create and improve the prediction model (and as a result accuracy) as soon as the third party 190 provides feedback via the qualitative review subsystem (e.g., the verification engine 140 and the third-party review device 106).

### III. Conclusion

The particular arrangements shown in the Figures should not be viewed as limiting. It should be understood that other embodiments can include more or less of each element shown in a given Figure. Further, some of the illustrated elements can be combined or omitted. Yet further, example embodiments can include elements that are not illustrated in the Figures.

Additionally, while various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are contemplated herein.

What is claimed is:

1. A system for document classification, the system comprising:
an electronic database configured to store a plurality of document specifications, each document specification having a corresponding classification label and one or more example documents associated with the corresponding classification label, the plurality of document specifications usable by a processor to generate training set data for a classification engine;
the classification engine configured to:
generate a classification model using the training set data;
receive a particular document;
based on the classification model, determine one or more classification labels for the particular document and a corresponding confidence value for each classification label; and
generate a classification report for the particular document, the classification report including the particular document, the one or more classification labels, and corresponding confidence values; and
a verification engine configured to:
request third-party review of the classification report;
based on the third-party review, assign a particular classification label to the particular document; and
transmit the particular document and the particular classification label to the electronic database as feedback, the feedback usable by the processor to update the training set data.

2. The system of claim 1, wherein, as the feedback, the particular document is added as an example document to a particular document specification stored in the electronic database, the particular document specification having the particular classification label.

3. The system of claim 1, wherein, as the feedback, the particular document is used to create a new document specification in the electronic database in response to a determination that there is no existing document specification in the electronic database having the particular classification label, the new document specification having the particular classification label.

4. The system of claim 1, wherein, as the feedback, the particular document is used to delete one or more example documents from a particular document specification stored in the electronic database, the particular document specification having a classification label that is different from the particular classification label, and the one or more example documents having similar characteristics of the particular document.

5. The system of claim 1, wherein the classification engine is configured to perform a retraining operation to generate an updated classification model using the updated training set data.

6. The system of claim 5, wherein the retraining operation is performed periodically.

7. The system of claim 5, wherein the retraining operation is performed in response to the update of the training set data.

8. The system of claim 1, wherein the training set data comprises a set of example documents extracted from the electronic database for different classification labels.

9. The system of claim 1, wherein the electronic database includes a user interface to enable one or more personnel to:
search the plurality of document specifications;
modify at least one document specification of the plurality of document specifications; and add a document specification to the plurality of document specifications.

10. The system of claim 1, wherein the particular document and the particular classification label are exported to an external system.

11. The system of claim 1, wherein the classification engine is based on natural language processing (NLP).

12. The system of claim 1, wherein the classification engine is based on a convolutional neural network (CNN).

13. A method of document classification, the method comprising:
retrieving, at a processor, a plurality of document specifications stored at an electronic database, each document specification having a corresponding classification label and one or more example documents associated with the corresponding classification label;
generating training set data based on the plurality of document specifications;
running a classification engine to cause the classification engine to perform a first set of operations, the first set of operations comprising:
generating a classification model using the training set data;
based on the classification model, determining one or more classification labels for a particular document and a corresponding confidence value for each classification label; and
generating a classification report for the particular document, the classification report including the particular document, the one or more classification labels, and corresponding confidence values;
running a verification engine to cause the verification engine to perform a second set of operations, the second set of operations comprising:
requesting third-party review of the classification report;
based on the third-party review, assigning a particular classification label to the particular document; and
transmitting the particular document and the particular classification label to the electronic database as feedback; and
updating the training set data based on the feedback.

14. The method of claim 13, wherein, as the feedback, the particular document is added as an example document to a particular document specification stored in the electronic database, the particular document specification having the particular classification label.

15. The method of claim 13, wherein, as the feedback, the particular document is used to create a new document specification in the electronic database in response to a determination that there is no existing document specification in the electronic database having the particular classification label, the new document specification having the particular classification label.

16. The method of claim 13, wherein, as the feedback, the particular document is used to delete one or more example documents from a particular document specification stored in the electronic database, the particular document specification having a classification label that is different from the particular classification label, and the one or more example documents having similar characteristics of the particular document.

17. A non-transitory computer-readable storage medium comprising instructions that, when executed by a processor, cause the processor to perform functions comprising:
retrieving a plurality of document specifications stored at an electronic database, each document specification having a corresponding classification label and one or more example documents associated with the corresponding classification label;
generating training set data based on the plurality of document specifications;
running a classification engine to cause the classification engine to perform a first set of operations, the first set of operations comprising:
generating a classification model using the training set data;
based on the classification model, determining one or more classification labels for a particular document and a corresponding confidence value for each classification label; and
generating a classification report for the particular document, the classification report including the particular document, the one or more classification labels, and corresponding confidence values;
running a verification engine to cause the verification engine to perform a second set of operations, the second set of operations comprising:
requesting third-party review of the classification report;
based on the third-party review, assigning a particular classification label to the particular document; and
transmitting the particular document and the particular classification label to the electronic database as feedback; and
updating the training set data based on the feedback.

18. The non-transitory computer-readable storage medium of claim 17, wherein, as the feedback, the particular document is added as an example document to a particular document specification stored in the electronic database, the particular document specification having the particular classification label.

19. The non-transitory computer-readable storage medium of claim 17, wherein, as the feedback, the particular document is used to create a new document specification in the electronic database in response to a determination that there is no existing document specification in the electronic database having the particular classification label, the new document specification having the particular classification label.

20. The non-transitory computer-readable storage medium of claim 17, wherein, as the feedback, the particular document is used to delete one or more example documents from a particular document specification stored in the electronic database, the particular document specification having a classification label that is different from the particular classification label, and the one or more example documents having similar characteristics of the particular document.
